(19) United States
(12) Patent Application Publication
(10) Pub. No.: US 2026/0366628 A1
(43) Pub. Date: Nov. 19, 2026

(54) A VALVE-SPOOL, A SEQUENCE VALVE COMPRISING THE VALVE-SPOOL, AND A METHOD OF OPERATING THE VALVE

(71) Applicant: CCB Subsea AS, ÅGOTNES (NO)

(72) Inventor: Fredrik Normann HANSEN, RÅDAL (NO)

(73) Assignee: CCB Subsea AS, ÅGOTNES (NO)

(21) Appl. No.: 19/148,422

(22) PCT Filed: Feb. 14, 2024
(86) PCT No.: PCT/NO2024/050036

§ 371 Date: Jul. 16, 2025

(30) Foreign Application Priority Data
Feb. 27, 2023 (NO) 20230194

(51) Int. Cl. F16K 11/07

(52) U.S. Cl. CPC F16K 11/0712; F16K 11/0708

(57) ABSTRACT

A valve-spool, and a sequence valve including the valve-spool, and a method for operating the sequence valve, wherein the sequence valve is provided with mechanical means for partially rotating the valve-spool with respect to a valve housing when the valve-spool is displaced so that mechanical means are in engagement. A movement of the valve-spool from a retracted position towards an extended position with respect to the valve housing is caused by a fluid pressure through an inlet of the valve, while a return of the valve-spool is caused by a biasing means. The valve is configured for cycling through a predetermined open or stay-closed sequence, where supply pressurization, with subsequent pressure relief, will generate each active and passive cycle step, respectively.

### CROSS-REFERENCE TO RELATED APPLICATIONS

This application is the U.S. national stage application of International Application No. PCT/NO2024/050036, filed Feb. 14, 2024, which international application was published on Sep. 6, 2024, as WO 2024/181867 in the English language. The International Application claims priority to Norwegian Patent Application No. 20230194, filed on Feb. 27, 2023. The international application and Norwegian application are both incorporated herein by reference, in their entirety.

### FIELD

This invention relates to valve-spool, a sequence valve, and a method for operating the valve. More specifically, the invention is related to a sequence valve comprising a valve-spool that is pressure-responsive, and when it is pressure activated, will interact with mechanical sequencing features. The valve is configured for a predetermined opening or stay-closed sequence, where pressurization via the supply port, followed by pressure relief, drives each active and passive cycle stage, respectively.

### BACKGROUND

The main purpose of the invention is to eliminate hydraulic, or electric control distribution to the operated equipment. An example is operation of tools for subsea well intervention, well completion, or well permanent plugging and abandonment, (PP&A). The traditional solution is to operate the equipment from a workover control system, WOCS, via a direct hydraulic control umbilical, clamped along a work-string inside the marine drilling riser. Potential damage to the umbilical, and consequences of loose parts from damaged umbilical clamps falling through the drilling riser, to the subsea BOP, constitute a significant risk of lost productive rig time. The problems and economic consequences of such incidents will increase with increasing water depth.

Several attempts have been made to develop umbilical-less solutions, because of the mentioned, and other disadvantages of clamping an umbilical to a work-string, and the advantages that an umbilical-less tooling system would provide, i.e., reduced cost, less space and weight of WOCS umbilical systems, increased efficiency, reduced damage potential for the completion string and personnel, lower equipment cost, etc.

One such umbilical-less solution is known in the patent literature from WO 2022/093033 A1. The operation steps are sequentially linked to inherent mechanical design features of the tool, i.e., mechanical functions activated through work string rotation, combined with pressurization of hydraulic ring-pistons, which are equipped with shear pin arrangements that will break at defined pressure levels. Hydraulic power will be supplied from the surface, pressurising a closed-in annular space below a pipe ram in the BOP. The pressure is supplied through an external high-pressure tubular, i.e., choke and kill lines that are integrated with the marine drilling riser and connected to the BOP.

The invention has for its object to eliminate the need for hydraulic, or electric control distribution to operated equipment, and to remedy or to reduce at least one of the drawbacks of the prior art, or at least provide a useful alternative to prior art. One useful application of the invention will be to mitigate the limitations and design complexity associated with umbilical-less sequencing of tool operation steps solely by means of mechanical manipulation via working string rotation and pressure-activated shear pin arrangements for the actuation of hydraulic ring pistons, as described in WO 2022/093033 A1.

Publication U.S.2020347947 A1 discloses a drill string safety valve device, comprising: a body with a through-going flow bore and connectors at respective ends of the flow bore for connection to tubulars; and a valve member movably arranged in said flow bore and configured for being locked into one of two states, wherein a first state of the valve member allows fluid to flow in both directions though the flow bore, and wherein a second state of the valve member allows fluid flow through the flow bore in only one direction.

Publication U.S.2019128100 A1 discloses a drain-back check valve assembly that includes a body having a passageway with an inlet and an outlet. A bypass port extends from the passageway to an outer surface of the valve body. A main poppet valve assembly is disposed in the passageway and moveable between a closed position which prevents fluid flow from the outlet to the inlet and an open position which allows fluid flow from the inlet to the outlet.

Publication U.S.2018/0283122A1 discloses a downhole tool for use in wellbores. The tool has a first position wherein fluids entering the tool can exit via two or more flow passages, and a second position wherein some of the two or more flow passages are blocked such that fluids in the tool exit via the remaining unblocked flow passages. The tool is transitionable between the first and second positions by alternately ceasing or decreasing fluid flow to the tool and introducing or increasing fluid flow to the tool.

### SUMMARY

The object is achieved according to the invention, through the features specified below, and in the subsequent patent claims.

In a first aspect of the invention, there is provided a valve-spool for a sequence valve configured for cycling through a sequence of valve open or stay closed steps, the valve-spool comprising:
an oblong body resembling a piston having a top portion and a bottom portion, and a rod; wherein the piston comprises a cavity having:
at least one bore through a wall of the piston;
a central bore through the top portion of the piston, the central bore configured for receiving a valve-spool shaft, and comprises an annular seal; and
a first annular dynamic seal arranged between the top portion of the piston and the at least one bore, and a second annular dynamic seal arranged between the bottom portion of the piston and the bore;
   the rod having a first end and a second end, the first end extending from said bottom portion of the piston, and comprises:
a guide key arranged on a portion of an outer surface of the rod, wherein the guide key has a tip between the first end and the second end of the rod, the tip configured for, in a position of use of the valve-spool, facing a top surface of an external valve-spool guide fixed with respect to a valve housing; and
a rod valve-spool guide secured to the end of the rod, and provided with inclined orienting notches configured for, in certain positions in use of the rod, mating with protrusions extending from an inner surface of the external valve-spool guide.

In a second aspect of the invention, there is provided a sequence valve configured for cycling through a sequence of valve open or stay closed steps, wherein the valve comprises:
the valve-spool according to the first aspect of the invention:
a valve housing having an axial bore for housing at least a portion of the valve-spool, a fluid supply port at a first position and a fluid outlet port at a second position being different from the first position with respect to a longitudinal axis of the bore;
a valve-spool shaft fixed to the housing and protruding into the cavity via the central bore through the top portion of the piston, the valve-spool shaft having a shaft diameter being smaller than a diameter of the cavity;
a biasing means for urging a valve-spool towards a retracted first position; wherein
the valve-spool is rotationally and axially movable within the housing between the retracted first position wherein fluid communication between the supply port and the outlet port is prevented, and an extended second position wherein fluid communication between the supply port and the outlet port is allowed, the radial bore configured communicating a pressurized fluid from the supply port into the cavity when the valve-spool is in a position wherein the supply port is aligned between the dynamic seals, wherein the valve further comprises:
   a fixed valve-spool guide having an end surface facing the tip of the guide key, wherein the end surface comprises inclined orientation profiles configured for rotating the guide key into a first key slot wherein fluid communication between the fluid supply port and the fluid outlet port is prevented, or into a second key slot allowing fluid communication between the fluid supply port and the fluid outlet port, wherein the first key slot is closer to the piston than the second key slot, and wherein the fixed valve-spool guide is further provided with protrusions for engaging the inclined orienting notches of the moveable valve-spool guide when the valve-spool is moved from its second position towards its first position.

Since the rod valve-spool guide is secured to the end of the rod, and the protrusions extending from the inner surface of the fixed external valve-spool guide, the sequence valve may be configured so that engagement between the protrusions and the inclined rotation notches takes place first when the tip of the guide key is moved away from its contact with a bottom portion of the first key slot or the second key slot. During such movement of the valve-spool, the engagement between the protrusions and the inclined rotation notches causes a rotational movement of the valve-spool with respect to the valve housing. The degree of rotation is determined by the length and angle of the inclined rotation notches.

In a preferred embodiment, the valve-spool is arranged in a bore of an insert-cartridge arranged in the bore of the valve housing, wherein the insert-cartridge is being provided with bores mating with the supply port and outlet port of the valve housing. An insert-cartridge is advantageous at least in view of manufacturing and subsequent maintenance of the sequence valve. In such an embodiment, the stationary valve-spool shaft may be secured to an end lid of the insert-cartridge. In an alternative embodiment, the valve-spool shaft may be secured to a separate lid secured to an end portion of the valve housing.

The biasing means may enclose a portion of the rod of the valve-spool.

In one embodiment, the fixed valve-spool guide and the rod valve-spool guide are interchangeable, so that the open or stay-closed sequence steps of the valve can be adapted to desired need by means of a combination and number of first key slots, second key slots, the protrusions of the fixed valve-spool guide, and the number of inclined orientation notches in the rod valve-spool guide. This has the effect that the sequence steps, and the degree of rotation between each step, can be adapted to desired needs without a need for replacing the complete sequence valve.

In a third aspect of the invention, there is provided a method of operating the sequence valve according to the second aspect of the invention, the method comprising:
a) supplying a pressurized fluid via the supply port and the at least one bore of the piston, into the cavity to effect axial movement of the valve-spool from its retracted first position towards its extended second position;
b) if it is desired to open for fluid communication between the supply port and the outlet port, then the method comprises either step:
c1) if the valve does not open, this indicates that the tip of the of the guide key abuts against a first key slot, the method comprises rotating the valve-spool within the housing to a next step by releasing the pressure so that the valve-spool is urged towards its retracted first position by means of the biasing means, while at the same time being rotated by means of the engagement between protrusions and the inclined orienting notches of the movable valve-spool guide, and then repeating step a) until the the tip of the of the guide key abuts against a second key slot, whereupon fluid communication between the supply port and the outlet port is achieved and the valve is open; or step
c2) if the valve opens, this indicates that the tip of the of the guide key abuts against a second key slot, and continuing supplying pressurized fluid sufficient to keep the valve open for a desired period of time.

From the above, it should be clear that the sequence valve is mechanically configured to cycle through stay-closed or open operation steps, driven by means of cycles of pressurized fluid, and the biasing means configured for urging the valve-spool towards its retracted first position.

The sequence valve solution may therefore be configured to perform a predetermined opening and closing cycle, for instance opening at every second pressurization. Other configurations may provide more complex open/close sequences, such as three times close, and opening on the fourth pressure pulse, or opening on one pressure signal, and then stay closed during subsequent pressurizations. One, or several sequencing valves may be arranged to operate certain hydraulic tool functions, possibly in combination with other means of umbilical-less actuation of tool functions that are known from publication WO 2022/093033 A1.

If the valve-spool has been axially displaced into the second (deep) key slot, the valve-spool will be sufficiently displaced so that that supply pressure will by-pass the first annular dynamic seal around piston of the valve-spool and will flow to the outlet port of the valve. The supply pressure will then act on the top portion of the piston of the valve-spool, providing a force to displace the valve-spool further into the deep key slot, against the spring force, as pressure builds up. When fluid pressure is relieved so that the force from the biasing means exceeds the fluid pressure, the valve-spool will move towards its retracted position while at the same time being rotated a certain degree around its longitudinal axis. The degree of rotation during a return movement depends on the configuration of the valve-spool guide as discussed above.

During an active sequence step, i.e., movement of the valve-spool from a retracted position to an extended position, the guide key of the rod of the valve-spool will hit the inclined end surface of the fixed valve-spool guide, so that the valve spool will be partially rotated, at the same time as it will be guided into one of several first or second key slots extending from the end surface around the fixed valve-spool guide. Depending on the respective key slot length, the allowable displacement of the pressurized valve-spool will either provide passage of pressurized fluid from the inlet to the outlet port, or not. In the latter case the sequence valve will be kept closed. When bleeding off supply pressure, with subsequent return of the valve-spool caused by the biasing means, the inclined orientating notches of the rod valve-spool will slide against the protrusions of the fixed valve-spool guide. The valve-spool will thus be axially turned in position for the next, active sequence step.

A pressurized stay-closed valve operation step may comprise the steps of:
a) supplying a pressurized fluid into the cavity of the piston so that the fluid pressure exerted on the difference in area between the internal diameter of the cavity and the diameter of the valve-spool shaft results in an axially directed force which overcomes the static friction between the housing (or insert-cartridge) and the valve-spool, and also the force of the spring; and
b) the valve-spool will move towards its extended position, while compressing the biasing means. The guide-key of the valve-spool will first hit an inclined edge of the fixed valve-spool guide, whereby the valve-spool will be forced to rotate before it enters a first (shallow) key slot in the fixed valve-spool guide. Limited axial displacement of the valve-spool as it bottoms-out in the first key slot does not allow any flow of pressurized fluid to the outlet port, since the first dynamic seal of the piston will still seal above the supply port in the centre bore of the valve housing (or insert-cartridge in an embodiment wherein the valve is provided with this); and
c) the compressed biasing means, typically a spring, will return the valve-spool as the supply pressure is relieved. Inclined edges of the rod valve-spool guide will then slide against the fixed protrusions of the fixed valve-spool guide, and the valve-spool will be forced to rotate to a starting position for a next sequence step.

A pressurized open valve operation comprises the steps of:
d) supplying a pressurized fluid into the cavity of the piston so that the fluid pressure exerted on the difference in area between the internal diameter in the cavity and the diameter of the valve-spool shaft results in an axially directed force which overcomes the static friction between the housing (or insert-cartridge) and the valve-spool, and also the force of the spring; and
e) the valve-spool will move towards its extended position, while compressing the biasing means. The axial movement of the valve-spool towards it extended position will at one point allow pressurized fluid to flow past the first dynamic seal of piston of the valve-spool, to the outlet port. The top portion of the piston and the first dynamic seal will then be subject to the pressurized fluid; and
f) during the axial displacement of the valve-spool towards its extended position, the guide-key of the rod will first hit an inclined edge of the fixed valve-spool guide, whereby the valve-spool will be forced to rotate before it enters a second (deep) key slot of the fixed valve-spool guide. Increased force from pressure exerted at the top portion of the piston of the valve-spool will displace it further, with continued compression of the spring, until it bottoms-out in the second key slot, and
g) keeping the valve open by means of the supply pressure until it is desired to close the valve by relieving the supply pressure, whereupon
h) the compressed biasing means will return the valve-spool as the supply pressure is relieved. Inclined edges of the rod valve-spool guide will then slide against the protrusions of the fixed valve-spool guide, and the valve-spool will be forced to rotate to a starting position for the next sequence step.

### BRIEF DESCRIPTION OF THE DRAWINGS

In what follows, an example of a preferred embodiment and method, with the sequence valve configured to stay closed every second time it is pressurized is described, and is visualized in the accompanying drawings, where:

FIG. 1A shows a side view of an outer body of the sequencing valve, comprising the valve-spool according to one embodiment of the invention;

FIG. 1B shows a cross-section of the valve through A-A in FIG. 1A, wherein the valve is in a pressurized state;

FIG. 2A shows in a smaller scale a mirrored cross-section of the valve in FIG. 1B, wherein the valve is in an un-pressurized state;

FIG. 2B shows in a larger scale a detail of a portion of the valve shown in FIG. 2A;

FIG. 2C shows in a larger scale a perspective view of a portion of a valve-spool according to an embodiment of one aspect of the invention, wherein the valve-spool forms part of the valve according to a second aspect of the invention;

FIG. 3A shows a cross-section of the valve in FIG. 2A, wherein the valve-spool has moved to its fully open position;

FIG. 3B shows in a larger scale a detail of a portion of the valve shown in FIG. 3A;

FIG. 3C shows a perspective view of the valve-spool in its end position of a valve open sequence step;

FIG. 4A shows the valve spool in FIG. 3C in an intermediate position during a stay-closed valve sequence step;

FIG. 4B shows the valve-spool in FIG. 4A being in the end position of a valve stay-closed sequence step;

FIGS. 5 A-B show perspective views of a spring return step of the valve-spool;

FIGS. 6 A-C show, in a smaller scale, perspective views of incremental displacements and partial rotation of the valve-spool, during a valve “opening” sequence step.

### DETAILED DESCRIPTION OF THE DRAWINGS

The drawings are shown in a schematic and simplified manner, and features that are not necessary for explaining the invention, such as seals, may have been left out. Identical reference numerals refer to identical or similar features in the drawings. For clarity reasons, some elements may in some of the figures be without reference numerals. The various features shown in the drawings may not necessarily be drawn to scale. A person skilled in the art will understand that the figures are just principal drawings. The relative proportions of individual elements may also be distorted. Any positional indications, such as for example upper and lower, refer to the position shown in the figures.

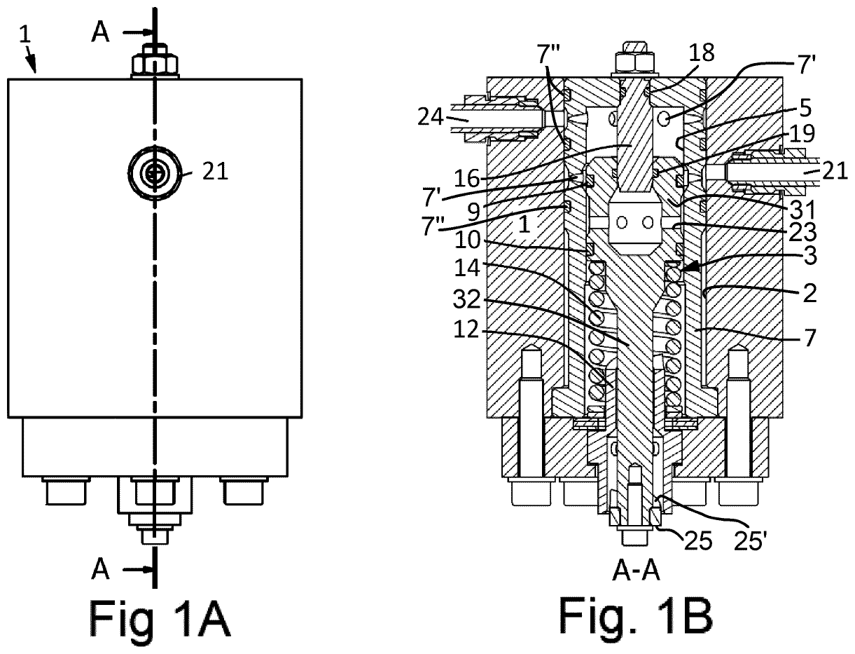

Reference is first made to FIG. 1A, where a sequence valve body 1 is shown. Although the valve body 1 is shown as a separate item, internal valve components of one, or several valves will typically be integrated into a larger tool body, (not shown), depending on the application.

FIG. 1B shows a cross-section through A-A of the valve body 1 shown in FIG. 1A. The sequencing valve according to the invention comprises an oblong valve spool 3 according to the first aspect of the invention, wherein the valve-spool comprises a piston 31 and a rod 32 extending from a bottom portion of the piston 31. The piston 31 has a larger diameter than the rod 32. The piston 31, and a part of the rod of the valve-spool 3 is in the embodiment shown arranged in a centre bore 5 of an insert-cartridge 7 having an end closure provided with an aperture, and an open end opposite the end closure. However, it should be noted that the valve-spool 3 in an alternative embodiment is arranged within the bore 2 of the valve housing, i.e., without the insert-cartridge 7.

The piston 31 is provided with a first seal groove comprising an annular, dynamic seal 9 and a second seal groove, comprising an annular dynamic seal 10. The first annular, dynamic seal 9, and second annular, dynamic seal 10 are configured for dynamically sealing against an internal face of the centre bore 5 of the insert-cartridge 7. The valve-spool 3 is arranged slidably in the centre bore 5 between a first position and a second position.

A valve-spool guide 12 is fixed relative to the cartridge 7 and is therefore denoted fixed valve-spool guide 12 hereinafter. The fixed valve-spool guide 12 protrudes into the open end of the bore 5 of the cartridge 7. A portion of the rod 32 extends into a centre bore of the fixed valve spool guide 12.

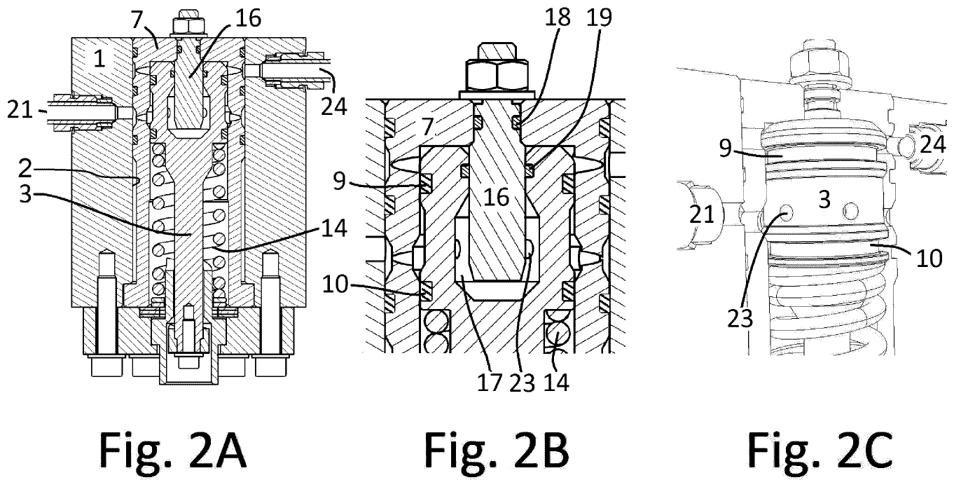

Reference is now made to the FIGS. 2A, 2B, and 2C. A portion of the rod 32 is surround-ed by a biasing means, here in the form of a spring 14. A valve-spool shaft 16 is connected to the end closure of the insert-cartridge 7, and extends through the aperture thereof and into a cavity 17 (see FIG. 2B) provided in the piston 31. The spring 14 is configured for urging the valve-spool 3 towards the end closure of the insert-cartridge 7 so that piston 31 abuts against an internal surface of the end closure of the insert-cartridge 7. The valve-spool shaft 16 is provided with a static seal 18 that seals against the aperture in the end closure of insert-cartridge 7. An entry bore of the cavity 17 of the piston 31 is provided with an annular groove configured for receiving a seal 19 for dynamically sealing against the valve-spool shaft 16 and the inside of the entry bore of the cavity 17.

As shown in FIGS. 1B, 2A, 3A, and 4A-6C, the pressure-responsive sequence valve is provided with a supply port 21 for communicating pressurized operation fluid through the housing 1 and the cartridge 7, and to the valve-spool 3. The piston 31 is provided with bores 23 for communicating operation fluid from the insert-cartridge 7 to the cavity 17. The bores are arranged between the seal grooves 9, 10 of the piston 31.

The valve is further provided with an outlet port 24 for communicating any fluid between the insert-cartridge 7 and a top portion of the piston 31 out of the sequence valve 1. It should be noted that the outlet port 24 represents a certain flow restriction, as will be appreciated by a person skilled in the art.

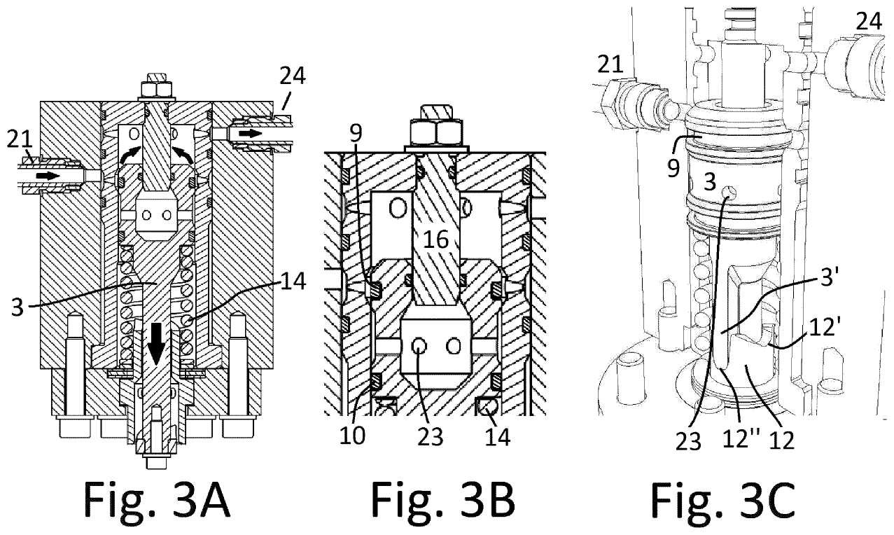

In FIGS. 2A-2C, the valve is in an initial position wherein a top portion of the piston 31 abuts against the inner surface of the end closure of the insert-cartridge 7 due to the force from the spring 14. When pressurized fluid is communicated through the supply port 21, the fluid will enter the cavity 17 in the piston 31, via the radial bores 23, (ref. also FIGS. 3B and 3C). The valve-spool 3 will then be axially displaced in the centre bore 5 of the insert-cartridge 7 when a net fluid force from pressurized fluid exerted on the difference in area between the internal diameter of the cavity 17 and the diameter of the valve-spool shaft 16 overcomes static friction and the spring 14 force.

Turning now to FIGS. 3A and 3B, and 3C illustrating a fully open sequence valve in cross-section and in perspective view, respectively.

In FIG. 3C, an embodiment of the fixed valve-spool guide 12, and an appurtenant guide key 3′ forming part of the valve-spool 3, are shown. The guide key 3′ is arranged on a portion of a surface of the rod 32.

The fixed valve-spool guide 12 is provided a first key slot 12′ and a second key slot 12″ extending from a top surface of the fixed valve-spool guide 12. An axial extent of the first key slot 12′ is less than an axial extent of the second key slot 12″. The first key slot 12′ and the second key slot 12″ may therefore be denoted shallow key slot 12′ and deep key slot 12″, respectively.

A tip of the guide key 3′ of rod 32 is configured to effect a partial rotation of the valve-spool 3 when the tip slides along an inclined surface of the fixed valve-spool guide 12 during a movement of the valve-spool 3 towards its extended position, until the tip is aligned with a key slot 12′, 12″. In FIG. 3C, the guide key 3′ has reached its end position in the second key slot 12″.

When the guide key 3′ of the valve spool 3 bottoms-out in the second key slot 12″ as shown in FIG. 3C, the valve-spool 3 is in its extended position. In its extended position, the first annular seal 9 (in the seal groove shown) is in an axial position with respect to the supply port 21 and bores through the insert-cartridge 7, allowing fluid communication into the open bore 5, (ref. also FIG. 1B), between the insert-cartridge 7 and a top portion of the piston 31. In this position, pressurized fluid is allowed to flow past the top portion of the piston 31 and thus an upper end of the valve-spool 3, to the outlet port 24. Pressure will, due to a certain flow restriction, and resistance by an external function (not shown), operated by the valve via the outlet port 24, build-up at the upper end of the valve-spool 3, due to the first annular dynamic seal 9 that encloses the piston 31 and seals against the internal bore 5 of the insert-cartridge 7. The fluid pressure acting on the top portion of the piston 31 effects a continued movement of the valve-spool 3 towards its extended position, with further compression of the spring 14, until a tip of the guide key 3′ abuts against, or bottoms out, in the deep, or second, key slot 12″.

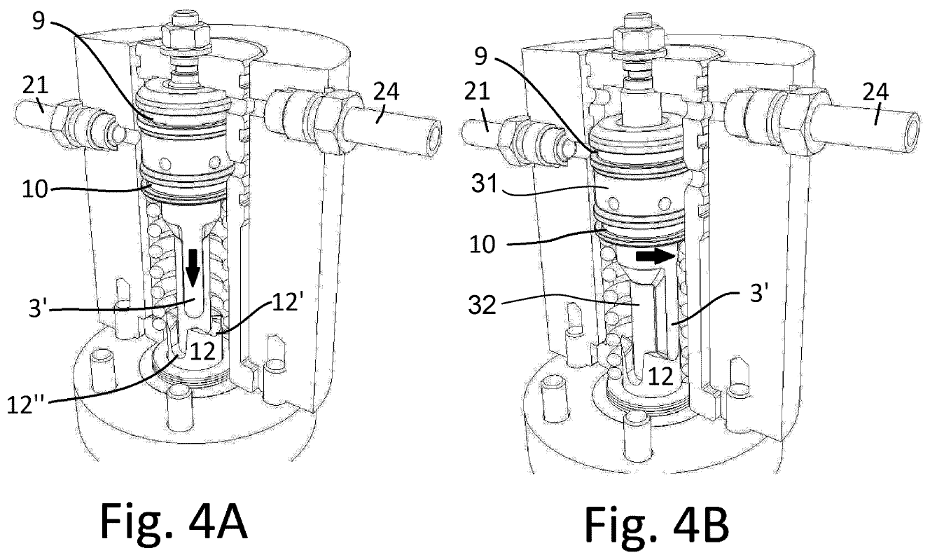

The individual key slots 12′, 12″ in the valve-spool guide 12 are made shallow or deep, according to a specified close/open sequence configuration. FIGS. 4A and 4B show an active, stay-closed valve sequence step. The valve-spool 3 is shown un-pressurized, or at the very beginning of a stay-closed movement in FIG. 4A. FIG. 4B shows the valve-spool 3 fully stroked and rotated into an end-position in the first, or shallow, key slot 12′ during the active sequence step. Limited axial movement of the valve-spool 3 does in this case not allow the operating fluid to flow to the outlet port 24, past the annular dynamic seal 9, which encircles an end portion of the piston 31.

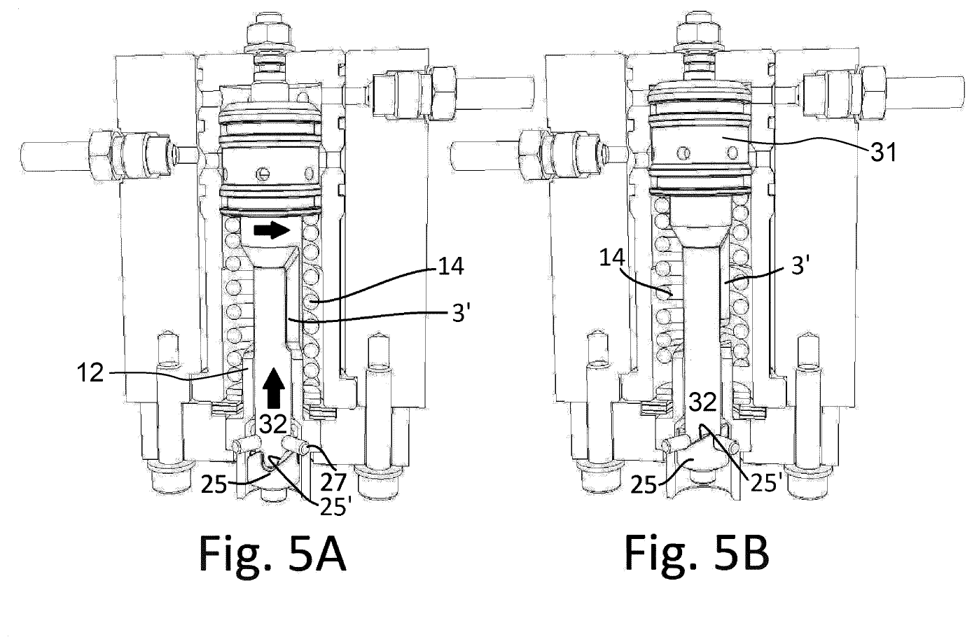

Reference is now made to FIGS. 5A and 5B, illustrating a passive spring return sequence step for the valve spool 3, as the inlet pressure from the supply port 21 is relieved. A moveable valve-spool guide 25 is fixed to and encloses a lower portion of the rod 32. The movable valve-spool guide 25 is configured for cooperating with protrusions, here in the form of guide-pins 27, that are fixedly connected to and protrude radially inwards from the fixed valve-spool guide 12. When the spring 14 returns the valve spool 3 from its extended second position, shown in for example FIG. 3C, via an intermediate position shown in FIG. 5A, to its retracted first position (end-position) shown in FIG. 5B, inclined orienting notches 25′ of the movable valve-spool guide 25 will abut and slide against the fixed guide-pins 27, and the valve-spool 3 is partially rotated (as illustrated by horizontal arrow), to a starting position for the next active sequence step. In the embodiment the rotation of the valve-spool 3 per active/passive sequence cycle is 90°. However, the degree of rotation may be more or less than 90° by other configurations of the fixed valve-spool guide 12, the fixed guide pins 27, and the movable valve-spool guide 25 adapted thereto.

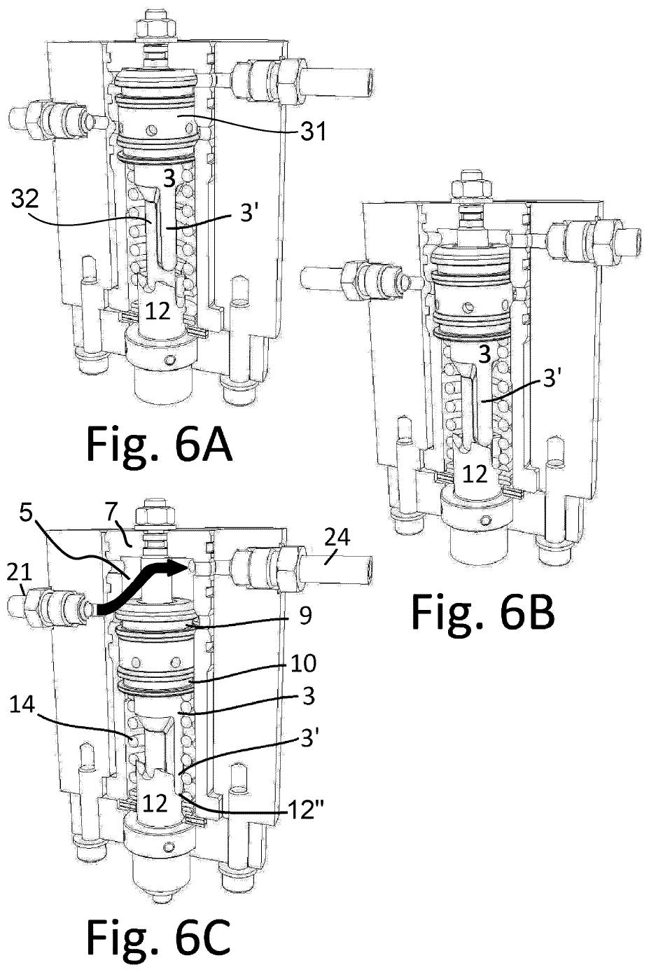

FIGS. 6A-6C show perspective views of an active open-valve sequence step. Reference is also made to the explanation to FIGS. 3A-3C. The valve-spool 3 is shown un-pressurized in FIG. 6A. FIG. 6B shows the valve-spool 3 guide-key 3′ when initially abut-ting against an inclined end surface, or edge, of the fixed valve-spool guide 12 during the axial downward displacement. When subject to further axial downward movement, the valve spool 3 is rotated while sliding along the inclined edge, until the guide key 3′ enters and bottoms-out in the second key slot 12″ of the fixed valve-spool guide 12. Reference is again made to the cross section image in FIG. 1B. In this position of the valve-spool 3, the first dynamic seal 9 is at a position with respect to the supply port 21 that allows fluid communication via a first set of radial bores 7′ in the insert-cartridge 7, past the first dynamic seal 9, into the evacuated part of the centre bore 5 of the insert-cartridge 7, and to the outlet port 24, via a second set of radial bores 7′ of the insert-cartridge 7. The radial bores 7′ through the insert cartridge are delimited by static seals 7″ that surround the insert-cartridge 7 inside the bore 2 of the valve body 1.

Necessary seals are not described, but are known to a skilled person.

It should be noted that the above-mentioned embodiment illustrates rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A valve-spool for a sequence valve configured for cycling through a sequence of valve open or stay-closed steps, the valve-spool comprising:
an oblong body resembling a piston having a top portion and a bottom portion, and a rod; wherein the piston is placed in a cavity and is provided with:
at least one bore through a wall, into a cavity of the piston; and
a central bore with an annular seal through the top portion of the piston, the central bore configured for receiving a valve-spool shaft; and
a first annular dynamic seal arranged between the top portion of the piston and the at least one bore, and a second annular dynamic seal arranged between the bottom portion of the piston and the bore;
the rod having a first end and a second end, the first end extending from said bottom portion of the piston, and comprises:
a guide key arranged on a portion of an outer surface of the rod, wherein the guide key has a tip between the first end and the second end of the rod, the tip configured for, in a position of use of the valve-spool, facing a top surface of an external valve-spool guide fixed with respect to a valve housing; and
a rod valve-spool guide secured to an end of the rod, and provided with inclined orienting notches configured for, in certain positions in use of the rod, mating with protrusions extending from an inner surface of the external valve-spool guide.

2. A sequence valve configured for cycling through a sequence of valve open or stay closed steps, wherein the valve comprises:
the valve-spool according to claim 1:
a valve housing having an axial bore for housing at least a portion of the valve-spool, a fluid supply port at a first position and a fluid outlet port at a second position being different from the first position with respect to a longitudinal axis of the bore;
a valve-spool shaft fixed to the housing and protruding into the cavity via the central bore through the top portion of the piston, the valve-spool shaft having a shaft diameter being smaller than a diameter of the cavity;
a biasing means for urging a valve-spool towards a retracted first position; wherein
the valve-spool is rotationally and axially movable within the housing between the retracted first position wherein fluid communication between the supply port and the outlet port is prevented, and an extended second position, wherein fluid communication between the supply port and the outlet port is allowed, the bore configured for communicating a pressurized fluid from the supply port into the cavity when the valve-spool is in a position wherein the supply port is aligned between the dynamic seals,
wherein the valve further comprises:
a fixed valve-spool guide having an end surface facing the tip of the guide key, wherein the end surface comprises inclined orientation profiles configured for rotating the guide key into a first key slot wherein fluid communication between the fluid supply port and the fluid outlet port is prevented, or into a second key slot allowing fluid communication between the fluid supply port and the fluid outlet port, wherein the first key slot is closer to the piston than the second key slot, and wherein the fixed valve-spool guide is further provided with protrusions for engaging the inclined orienting notches of the rod valve-spool guide when the valve-spool is moved from its second position towards its first position.

3. The sequence valve according to claim 2, wherein the valve-spool is arranged in a bore of an insert-cartridge arranged in the bore of the valve housing, the insert-cartridge being provided with bores mating with the supply port and outlet port of the valve housing.

4. The sequence valve according to claim 3, wherein the valve-spool shaft is secured to an end lid of the insert-cartridge.

5. The sequence valve according to claim 2, wherein the biasing means encloses a portion of the rod of the valve-spool.

6. The sequence valve according to claim 2, wherein the fixed valve-spool guide and the rod valve-spool guide are interchangeable, so that the open or stay-closed sequence steps of the valve can be adapted to desired need by means of a combination and number of first key slots, second key slots, the protrusions of the fixed valve-spool guide, and the number of inclined orientation notches in the rod valve-spool guide.

7. A method of operating the sequence valve according to claim 2, the method comprising:
a) supplying a pressurized fluid via the supply port and the at least one bore of the piston, into the cavity to effect axial movement of the valve-spool from its retracted first position towards its extended second position;
b) if it is desired to open for fluid communication between the supply port and the outlet port then the method comprises either step:
c1) if the valve does not open, this indicates that the tip of the of the guide key abuts against a first key slot, the method comprises rotating the valve-spool within the housing to a next step by releasing the pressure so that the valve-spool is urged towards its retracted first position by means of the biasing means, while at the same time being rotated by means of the engagement between protrusions and the inclined orienting notches the rod valve-spool guide, and then repeating step a) until the tip of the of the guide key abuts against the a second key slot, whereupon fluid communication between the supply port and the outlet port is achieved and the valve is open; or step
c2) if the valve opens, this indicates that the tip of the of the guide key abuts against the a second key slot, and continuing supplying pressurized fluid sufficient to keep the valve open for a desired period of time.

8. The sequence valve according to claim 3, wherein the biasing means encloses a portion of the rod of the valve-spool.

9. The sequence valve according to claim 4, wherein the biasing means encloses a portion of the rod of the valve-spool.
